(19) United States
(12) Patent Application Publication
(10) Pub. No.: US 2014/0004376 A1
(43) Pub. Date: Jan. 2, 2014

(54) HARD-FACED COMPOSITE ARTICLE

(71) Applicants: Robert J. Gaster, (US); Brent A. Augustine, (US)

(72) Inventors: Robert J. Gaster, (US); Brent A. Augustine, (US)

(21) Appl. No.: 13/536,197

(22) Filed: Jun. 28, 2012

(51) Int. Cl. B32B 15/04; B23K 31/00

(52) U.S. Cl. 428/627; 228/164

(57) ABSTRACT

A hard-faced composite article includes an iron-based substrate having a composition with less than 0.6% by weight of carbon, and a wear-resistance element joined to the iron-based substrate. The wear-resistance element has a metallic matrix and boron-containing regions dispersed through the metallic matrix.

### BACKGROUND

This disclosure relates to a composite article that has a hard-facing to protect an underlying substrate from abrasion or the like.

Component wear in agricultural, heavy equipment and other industries increases expenses due to component replacement or repair. Small components can be made entirely of wear-resistant material if wear is a concern. However, wear-resistant material is relatively expensive and it is not feasible to make large components entirely out of wear-resistant material. To reduce the amount of wear-resistant material, a component can be coated with the wear-resistant material. A wear-resistant coating can be applied using a spray-welding technique, such as flame or plasma spraying, or powder metal technique.

### SUMMARY

A hard-faced composite article according to the present disclosure includes an iron-based substrate that has a composition with less than 0.6% by weight of carbon. A wear-resistance element is joined to the iron-based substrate. The wear-resistance element has a metallic matrix and boron-containing regions dispersed through the metallic matrix.

In another aspect, a hard-faced composite article according to the present disclosure includes a metallic substrate that has a first hardness and a wear-resistance element that is joined to the metallic substrate. The wear-resistance element has a second, greater hardness and a composition that has alloy elements including boron, carbon, chromium and nickel. A combined amount by weight of boron and carbon being 0.6%-6.5% and a combined amount by weight of nickel and chromium being 5%-80%.

A method of processing a hard-facing according to the present disclosure includes forming a wear-resistance element having a metallic matrix and boron-containing regions dispersed through the metallic matrix.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example hard-faced composite article.

FIG. 2 illustrates a cross-section through a wear-resistance element.

FIG. 3 illustrates a cross-section through another example wear-resistance element.

FIG. 4 illustrates an example method of processing a wear-resistance element.

FIG. 5 illustrates an example implementation of a hard-faced composite article.

### DETAILED DESCRIPTION OF THE PREFERRED EMBODIMENT

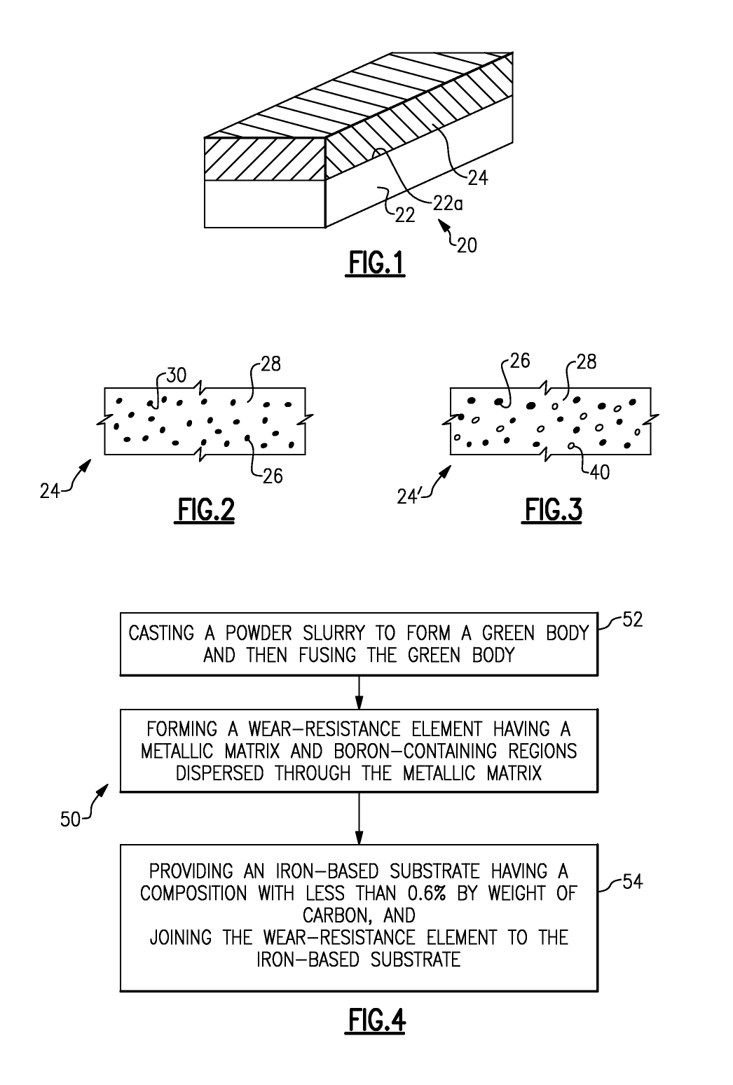

FIG. 1 is a schematic, perspective view of an example hard-faced composite article 20 (hereafter “article 20”). For example only, the article 20 may be a tool, agricultural implement, vehicle component or the like. It is to be understood, however, that the article 20 is not limited to such applications and may be used for other applications that would benefit from this disclosure.

The article 20 includes a metallic substrate 22 and a wear-resistance element 24 that is joined to the substrate 22. The metallic substrate 22 and the wear-resistance element 24 are shown schematically for the purpose of description and may have the actual shapes shown or may have any other shape suitable for the intended end use.

In one example, the metallic substrate 22 is an iron-based substrate that has a composition of greater than 60% by weight of iron or greater than 70% by weight of iron, with less than 0.6% by weight of carbon or with less than 0.4% by weight of carbon. In a further example, the metallic substrate 22 may have the composition of a mild or low carbon steel.

Referring also to a cross-sectional view taken through a portion of the wear-resistance element 24 shown in FIG. 2, the wear-resistance element 24 includes boron-containing regions 26. The term “region” as used herein refers to a volume having a compound that includes the named element. The boron-containing regions 26 are relatively uniformly dispersed through a metallic matrix 28. The boron-containing regions 26, such as chromium boride and/or complex multi-metal borides, are hard in comparison to the metallic matrix 28 and thus increase the overall, bulk hardness of the wear-resistance element 24. In this regard, the metallic substrate 22 has a first hardness and the wear-resistance element 24 has a second, greater hardness to thus protect the metallic substrate 22 from abrasion and the like.

In a further example, the wear-resistance element has a nickel-, iron- or cobalt-based alloy composition. The alloy composition can include alloy elements in individual amounts of 0.1-20% by weight of boron, silicon, chromium, iron (for nickel- and cobalt-based alloys), carbon, manganese, nickel (for iron- and cobalt-based alloys), tungsten and combinations thereof.

In a further example, the composition includes silicon and manganese in a combined amount of up to 4% by weight to strengthen and toughen the metallic matrix 28.

In a further example, a combined amount by weight of the boron and the carbon is 0.6-6.5% to control the amount of borides and carbides in the wear-resistance element 24, and a combined amount by weight of the nickel and the chromium is 5-80% to control the amount of nickel and chromium intermetallic phases in the wear-resistance element 24. In a further example, a combined amount by weight of the boron and the carbon is 4-6.5% and a combined amount by weight of the nickel and the chromium is 18-22%.

In a further example, the composition includes carbon in carbon-containing regions 30, such as chromium carbide and/or complex multi-metal carbides. The carbon-containing regions 30 can also include boron such that the carbon-containing regions 30 may also be considered to be boron-containing regions 26, and vice versa.

In a further example, the composition of the wear-resistance element is an example composition set forth in the Table below.

TABLE
Example Compositions 1-4, by weight percentage.

| | Example | | | |
|---|---|---|---|---|
| Element | 1 | 2 | 3 | 4 |
| Boron | 3 | 3.29 | 3.08 | 2 |
| Carbon | 0.7 | 2.18 | 1.98 | 0.6 |
| Chromium | 14.3 | 14.44 | 14.12 | 12.35 |
| Cobalt | — | — | — | Bal. |
| Iron | 4 | Bal. | Bal. | 1.3 |
| Manganese | — | 0.31 | 0.5 | — |
| Nickel | Bal. | 5.72 | 5.64 | 23.5 |
| Silicon | 4.25 | 3.09 | 2.74 | 1.9 |
| Tungsten | — | — | — | 7.6 |

In a further example, the boron-containing regions 26 and the carbon-containing regions 30 are present in the wear-resistance element 24 in a combined amount by volume percentage of 30%-50% to provide a relatively high hardness differential between the wear-resistance element 24 and the metallic substrate 22 having low carbon. Thus, the amount of the metallic matrix 28 by volume is greater than 50%.

In the illustrated example, the wear-resistance element 24 has a geometric shape, which may differ from that shown, depending on the design of the article 20. The wear-resistance element 24 is located on the surface 22a of the metallic substrate 22, which is subject to wear during use of the article 20. One or more of the wear-resistance elements 24 can selectively be used on the article 20 in areas that are subject to wear, while areas that are not subject to wear or that are subject to less wear may not be covered, which reduces the amount of material used and weight of the article 20.

FIG. 3 illustrates a cross-section through a portion of a modified wear-resistance element 24′. In this example, in addition to the boron-containing regions 26 and, optionally, carbon-containing regions 30, the wear-resistance element 24′ also includes tungsten carbide regions 40 to further increase hardness and enhance wear-resistance. In one example, the tungsten carbide regions 40 have an average size of 45 micrometers or less and are present in the wear-resistance element 24 in an amount up to 50% by weight. In a further example, the boron-containing regions 26, the carbon-containing regions 30 and the tungsten carbide regions 40 are present in the wear-resistance element 24′ in a combined amount by volume percentage of greater than 50% or, alternatively 30%-50% by volume.

FIG. 4 shows an example method 50 of processing the wear-resistance element 24/24′ as described herein. The method 50 includes forming the wear-resistance element 24/24′ having the metallic matrix 28 and at least the boron-containing regions 26, as described above. In this example, the wear-resistance element 24/24′ is pre-fabricated, separate from the metallic substrate 22. For instance, the forming includes casting, at step 52, a powder slurry into a green body of the desired shape of the wear-resistance element 24/24′. The green body is then fused at an elevated temperature to bond the powder together into a hard, self-supporting body. The selected elevated temperature depends upon the selected composition of the wear-resistance element 24/24′. In one example, the selected elevated temperature is lower than the melting temperature of the primary metallic element of the composition such that the powder fuses by solid state sintering. During the fusing, the boron and carbon, if present, form the boron-containing regions 26 and the carbon-containing regions 30. Alternatively, a separate heat treatment may be used to form the regions 26 and 30.

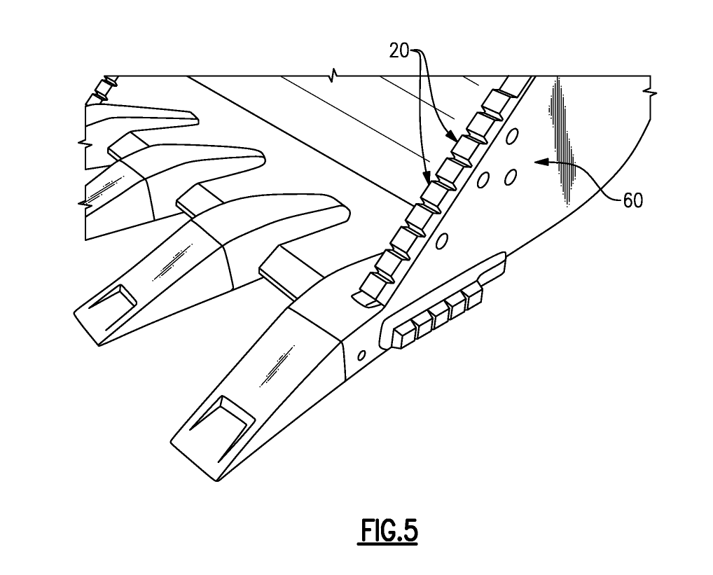

In a further example, the wear-resistance element is then joined, at step 54, to the metallic substrate 22. The wear-resistance element 24 can be joined by a continuous weld, a discontinuous stich weld, an adhesive, diffusion bonding, a fastener or the like, for example, to form the article 20. One or more of the articles 20 may then be attached, such as by welding, to an end use component. FIG. 5 shows one example implementation of the articles 20 welded onto a bucket 60, which may be attached to a vehicle.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A hard-faced composite article comprising:
an iron-based substrate having a composition with less than 0.6% by weight of carbon; and
a wear-resistance element joined to the iron-based substrate, the wear-resistance element having a metallic matrix and boron-containing regions dispersed through the metallic matrix.

2. The article as recited in claim 1, wherein the wear-resistance element includes carbon-containing regions.

3. The article as recited in claim 2, wherein the carbon-containing regions include chromium carbide.

4. The article as recited in claim 1, wherein the composition of the iron-based substrate includes greater than 60% by weight of iron.

5. The article as recited in claim 4, wherein the composition of the iron-based substrate includes greater than 70% by weight of iron.

6. The article as recited in claim 1, wherein the composition of the iron-based substrate includes less than 0.4% by weight of carbon.

7. The article as recited in claim 1, wherein the wear-resistance element has a geometric shape.

8. The article as recited in claim 1, wherein the wear-resistance element includes tungsten carbide regions.

9. The article as recited in claim 8, wherein the tungsten carbide regions have an average size of 45 micrometers or less.

10. The article as recited in claim 1, wherein the wear-resistance element includes carbon-containing regions, and a combined amount by volume percentage of the boron-containing regions and the carbon-containing regions in the wear-resistance element is 30%-50%.

11. The article as recited in claim 1, wherein the wear-resistance element has a composition including boron, carbon, chromium and nickel, and a combined amount by weight of boron and carbon is 0.6-6.5 and a combined amount by weight of nickel and chromium is 5-80.

12. The article as recited in claim 1, wherein the wear-resistance element has a composition including boron, carbon, chromium and nickel, and a combined amount by weight of boron and carbon is 4-6.5% and a combined amount by weight of nickel and chromium is 18-22%.

13. A hard-faced composite article comprising:
a metallic substrate defining a first hardness; and
a wear-resistance element joined to the metallic substrate, the wear-resistance element having a second, greater hardness and a composition that has alloy elements including boron, carbon, chromium and nickel, a combined amount by weight of boron and carbon being 0.6-6.5 and a combined amount by weight of nickel and chromium being 5-80.

14. The article as recited in claim 13, wherein the composition of the metallic substrate includes greater than 70% by weight of iron.

15. The article as recited in claim 13, wherein the wear-resistance element includes tungsten carbide regions.

16. The article as recited in claim 13, wherein the wear-resistance element includes carbon-containing regions, and a combined amount by volume percentage of the boron-containing regions and the carbon-containing regions in the wear-resistance element is 30%-50%.

17. The article as recited in claim 13, wherein the metallic substrate has a composition with less than 0.6% by weight of carbon.

18. The article as recited in claim 13, wherein the composition of the wear-resistance element includes silicon and manganese.

19. A method of processing a hard-facing, the method comprising:
forming a wear-resistance element having a metallic matrix and boron-containing regions dispersed through the metallic matrix.

20. The method as recited in claim 19, further comprising:
providing an iron-based substrate having a composition with less than 0.6% by weight of carbon; and
joining the wear-resistance element to the iron-based substrate.

21. The method as recited in claim 19, wherein the forming includes casting a powder slurry to form a green body and then fusing the green body.
